(19) United States
(12) Patent Application Publication
(10) Pub. No.: US 2010/0091806 A1
(43) Pub. Date: Apr. 15, 2010

(54) Semiconductor Lasers with Improved Temporal, Spectral, and Spatial Stability and Beam Profile Uniformity

(75) Inventors: Ningyi Luo, Fremont, CA (US); Sheng-Bai Zhu, Fremont, CA (US); Hui Fan, San Jose, CA (US); Jindong Li, Fremont, CA (US)

Correspondence Address: PAVILION INTEGRATION CORPORATION, 2380 QUME DRIVE, SUITE G, SAN JOSE, CA, 95131, US

(73) Assignee: Pavilion Integration Corporation, San Jose, CA (US)

(21) Appl. No.: 12/249,724

(22) Filed: Oct. 10, 2008

(51) Int. Cl. H01S 3/13

(52) U.S. Cl. 372/29.011; 372/29.021; 372/29.015

(57) ABSTRACT

A method for improving spectral, spatial, and temporal stability of semiconductor lasers and their beam profile uniformity based on statistical average of plural transient or unsteady state longitudinal and lateral modes that are continuously perturbed. A laser module implementing the method comprises a semiconductor laser, a drive circuit generating RF-modulated drive current, and an automatic power control loop for producing stable, low noise and uniform or nearly uniform illumination field along one or two dimensions.

### FIELD OF THE INVENTION

This invention relates in general to low-noise semiconductor lasers, and in particular, relates to temporally, spectrally, and spatially stabilized broad area semiconductor lasers that emit laser beams with low optical noise and uniform or nearly uniform illumination filed.

### BACKGROUND OF THE INVENTION

A typical laser diode consists of a planar semiconductor waveguide material with the end facets cleaved to form the resonator mirrors. The vertical transverse mode distribution, which extends along a direction perpendicular to the active layer (p-n junction) or fast axis, is primarily determined by the index-guided mechanism, and consequently has a Gaussian-beam profile, while the lateral transverse mode, which extends along a direction parallel to the p-n junction or slow axis, is determined by the waveguiding mechanism and the stripe width. An index guided laser typically has a relatively narrow stripe width and operates in a single transverse mode. On the other hand, a broad area laser diode having a wide stripe is typically gain guided or weakly index guided, and often operates in multiple lateral modes. In these lasers, a fundamental TEM₀₀ mode operation is observed in a current range just above the lasing threshold. As the injection current increases, higher order lateral modes come into play, and competition among lateral modes introduces random mode switching, which results in unstable laser operation. Unstable lateral modes will impair the uniformity of illumination along the direction in parallel to the p-n junction. In addition, its intensity distribution varies with the position along the beam propagation path. Other problems that may be induced by lateral mode competition include mode-partition noise, distortion of the light-current characteristic (kink), and lateral shift in the emission spot. Mechanisms that cause mode switching may include spatial hole-burning, thermal effects, and optical feedback/injection into the laser cavity.

Many laser applications require uniform illumination of target. For example, flow cytometry or multi-photon 3D imaging systems favor a laser beam with a Gaussian intensity profile along the fast axis and a flat-top or super Gaussian intensity profile along the slow axis. Traditionally, this can be achieved with various optical beam shaping systems, for instance, diffractive or refractive beam shapers using acylindrical lenses. These beam shaping systems are generally complicated and their optical response is wavelength-dependent. More importantly, optical beam shaping systems cannot reduce noise nor instability induced by random switching of the operation modes (mode hop), whether longitudinal or lateral or both.

Longitudinal and/or lateral mode hop can be eliminated or reduced by intentionally changing the modes at a high frequency, e.g., radio frequency (RF). For semiconductor lasers driven by electric current, the optical output wavelengths and lateral modes depend on the drive current because the refractive index is a function of the carrier density. When the drive current varies at a high frequency, the laser output wavelengths and lateral modes change accordingly. In practice, these changes are rapid and random. Averaged over time, the laser operation is stabilized, mode hop related noise is suppressed or reduced, and for lasers expanded in one or two dimension(s), uniform illumination can be obtained.

Employing RF modulated drive current to stabilize operation of laser diode has been disclosed or taught by a number of inventors. Exemplary inventions can be found in the U.S. Pat. Nos. 5,065,401; 5,175,722; 5,197,059; 5,386,409; 5,495,464; 6,049,073; 6,625,381; and 6,999,838. Examples that employ dithering current for stabilization of laser operation based on coherence collapse include the U.S. Pat. Nos. 6,215,809 and 6,240,119. Almost all of these inventions are related to stabilization of the longitudinal modes. The only exception is U.S. Pat. No. 5,065,401, in which Scifres et al. teach a method of stabilizing the output intensity of multiple transverse mode lasers in pulsed operation. The method has a pulse circuitry providing a sequence of drive current pulses to the laser and a modulation circuitry superimposing a modulation current upon the drive current pulses. The pulse circuitry further includes a switching driver element for providing drive current pulses in response to a PULSE TRIGGER signal. There is no teaching or suggestion on stabilizing multimode (lateral) laser operation in continuous wave (CW) mode. Moreover, none of the prior art has disclosed or taught improvement of spatial uniformity along one or two expanded dimension(s) of the laser beam by means of varying the drive current.

To obtain uniform illumination along an expanded axis, the laser must be operated in a sufficiently large number of lateral modes. On average, the intensity distributions of these lateral modes compensate each other so that superimposition of these modes provides a nearly uniform illumination along this axis. However, even along an expanded axis, the number of lateral modes in steady state is still very limited. Moreover, the fundamental mode and low-order lateral modes always dominate higher order modes with higher diffraction losses. A further complication is due to the fact that different lateral modes have different effective path lengths within the cavity, and consequently demonstrate different frequencies. All these make conventional non-optical approach to smoothing the spatial distribution of laser beam intensity difficult. In fact, no success in this aspect has so far been reported.

Our invention advantageously addresses the deficiencies of the prior art and enables stable operation of a broad area laser or a phase-locked laser array or a Vertical Cavity Surface Emitting Laser (VCSEL) operated in multiple spatial modes or any other electronically excited semiconductor laser with at least one expanded dimension(s), along which the optical profile(s) are flat-top or quasi-flat-top or super-Gaussian.

### SUMMARY OF THE INVENTION

In view of the foregoing observation, the object of the present invention is to provide a method for stabilizing output power, wavelength, and lateral intensity profile of a laser with nearly flat-top or super-Gaussian intensity distribution along one or two expanded dimension(s) and, based on the method, a device emitting laser beam of stable, low-noise, and uniform or nearly uniform illumination field.

According to our invention, spectrally and spatially stabilized laser operation is achieved by statistical averages of transient or unsteady-state longitudinal and transverse modes. In order to obtain the transient or unsteady-state modes, the laser drive current is modulated in amplitude at a frequency so high that competition of longitudinal modes and buildup of lateral modes are not completed within each modulation cycle or are continuously perturbed during the operation. The modulation waveform is selectable and the depth and frequency of the modulation are variable to take into account of various requirements including incomplete mode competition, sufficient perturbation to the instantaneous beam profiles, output power and other laser characteristics.

According to our invention, flat-top or quasi-flat-top or super Gaussian profile of the laser beam along one or two expanded dimension(s) is achieved by statistical averages of transient or unsteady-state profiles of lateral modes, which have time-varying field patterns. These transient or unsteady-state profiles have relatively uniform distributions across the aperture in comparison with the steady-state profiles. In general, the lateral intensity distribution initiates from a random pattern. The higher order lateral modes take more successive round trips to buildup and less successive round trips to attenuate than lower order modes. Transient profiles are a consequence of uncompleted buildup of lateral modes. Unsteady-state profiles can be obtained by continuous perturbation of the gain and loss. Taking statistical averages of transient or unsteady states will overcome the difficulty caused by insufficient number of steady-state lateral modes.

According to our invention, stable laser output power is achieved by an automatic optical power control system comprising laser output monitoring, photon-electron conversion, and a feedback loop to adjust the bias based on the detected signal. Advantageously, the automatic power control loop is less perturbed by fluctuations in the temperature. It effectively suppresses detrimental effects from stray lights and other unwanted optical feedback, meanwhile the sampling sensitivity is improved.

The invention, as well as its objects and advantages, will become more apparent from the drawings and detailed description presented hereinafter.

### BRIEF DESCRIPTION OF THE DRAWINGS

FIG. 1A shows attenuation of laser lateral modes of different orders on successive round trips;

FIG. 1B shows buildup of lateral modes of different orders at laser turn-on;

FIG. 2A shows transient distribution of the laser lateral modes and its dependence on the number of round trips propagated within each on-off cycle, (a) lower on-off rate, more round trips, (b) higher on-off rate, less round trips;

FIG. 2B shows transient distribution of the laser lateral modes in repeated on-off operation;

FIG. 2C compares steady-state TEM₀₀ mode with its transient profile;

FIG. 3A shows an embodiment of the laser driving circuit according to the present invention;

FIG. 3B shows an embodiment of the RF modulation circuitry according to the present invention;

FIG. 3C shows another embodiment of the RF modulation circuitry according to the present invention;

FIG. 4A demonstrates experimental results to compare lateral profiles of a broad laser emitter with (a) or without (b) implementation of the present invention;

FIG. 4B demonstrates experimental results to compare 3D intensity distribution patterns of a broad laser emitter with (a) or without (b) implementation of the present invention;

FIG. 5A demonstrates experimental results to compare the stability of the lateral profiles of a broad laser emitter when the operation temperature changes from 20° C. to 25° C., with (a) or without (b) implementation of the present invention;

FIG. 5B demonstrates experimental results to compare the stability of the lateral profiles of a broad laser emitter when the DC bias changes from 150 mA to 152 mA, with (a) or without (b) implementation of the present invention

### DETAILED DESCRIPTION OF THE PRESENT INVENTION

As will be described in more detail hereafter, there is disclosed herein a method for stabilizing output power, wavelength, and lateral intensity profile of a laser with nearly flat-top or super-Gaussian intensity distribution along one or two expanded dimension(s) and, based on the method, a device emitting laser beam of stable, low noise, and uniform or nearly uniform illumination field.

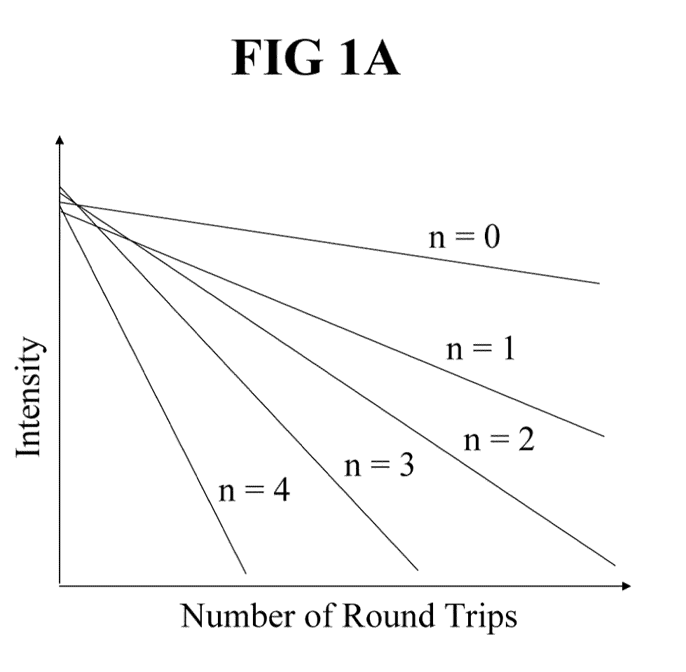

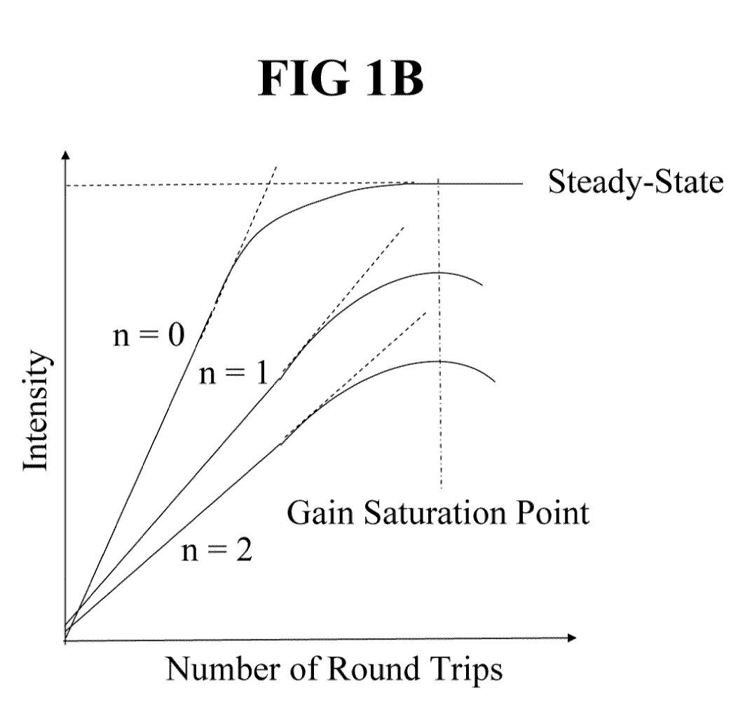

FIG. 1A shows attenuation of laser lateral modes of different orders (n=0 the lowest) on successive round trips. Since lasing initiates from spontaneous emission over the gain medium, the starting field on average should have a uniform pattern across the end mirrors. In round trip wave propagation, higher-order lateral modes experience higher diffractive losses and attenuate in faster rates. After a sufficient number of round trips, the lowest-order lateral mode becomes dominant.

FIG. 1B shows buildup of lateral modes of different orders at laser turn-on. When a laser oscillator is turned on, an initial mode distribution determined by noise or spontaneous emission in the cavity begins to circulate repeatedly and grows in amplitude if the cavity is above threshold. The lowest order lateral mode grows the fastest because it has the highest value of net gain minus loss. Eventually, the laser saturates the gain medium, the lowest-order lateral modes will then stay at their steady state levels, whereas all the higher-loss modes die out in the same way as illustrated in FIG. 1A.

There are cases, in particular in a laser medium of high gain and/or of different gains to different eigenmodes across the laser, where the lowest lateral modes saturate the gain medium only in certain regions of the lateral plane, while leave unsaturated at other regions, which may allow higher-order lateral modes (higher spatial frequency components) to oscillate simultaneously. Non-uniform gain across the laser and interference between the fields of different lateral modes may cause the laser jump back and forth among different lateral modes (spatial mode hop). Lateral mode switching may also be caused by spatial hole-burning, thermal effects, and optical feedback/injection into the laser cavity. Mechanisms that cause fundamental lateral transverse mode instability of stripe geometry injection lasers were studied by Roy Lang based on numerical calculations. [Roy Lang, “Lateral transverse mode instability and its stabilization in stripe geometry injection lasers”, IEEE Journal of Quantum Electronics, Vol. 15, Issue 8, 718-726, 1979].

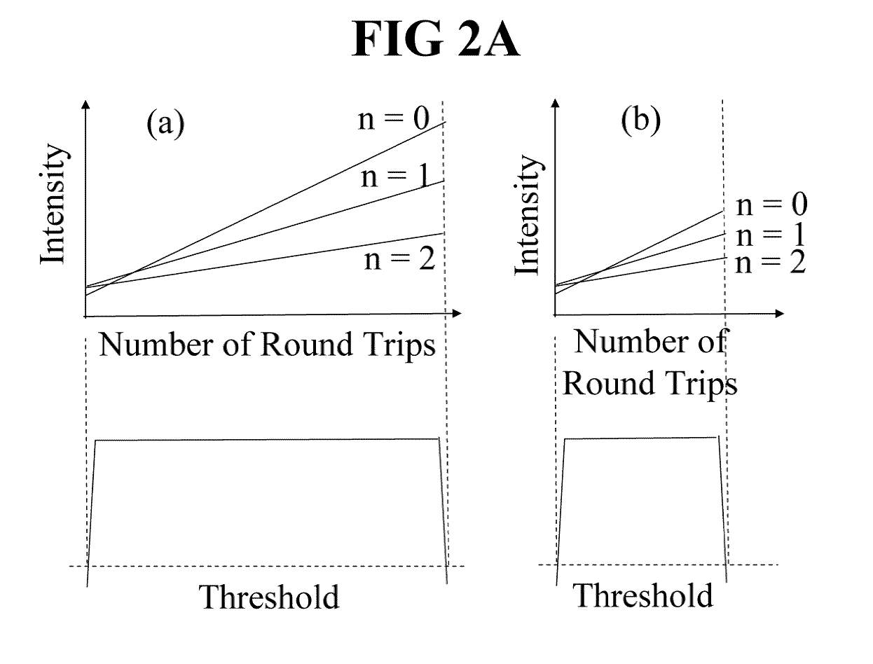

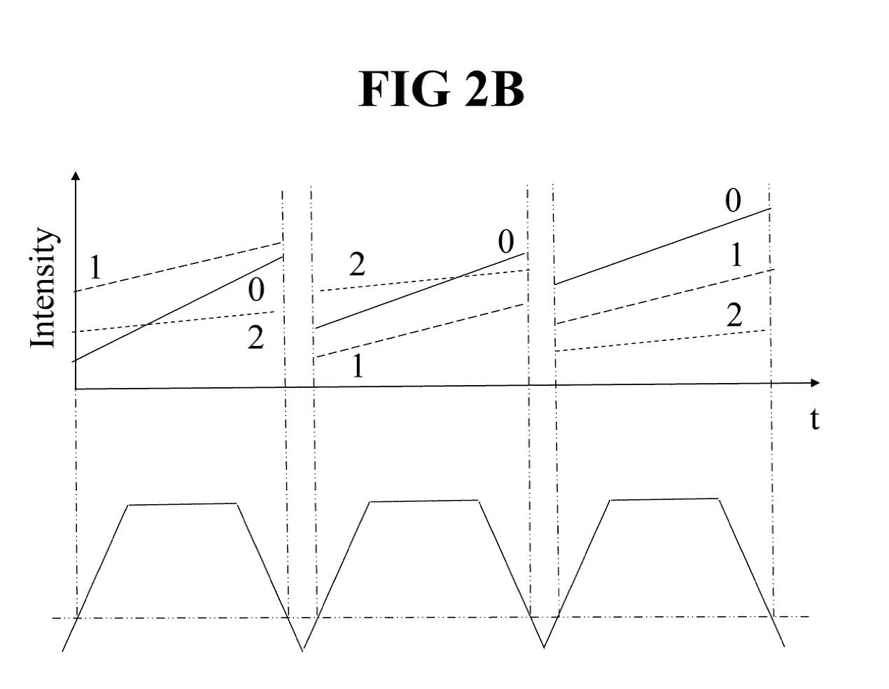

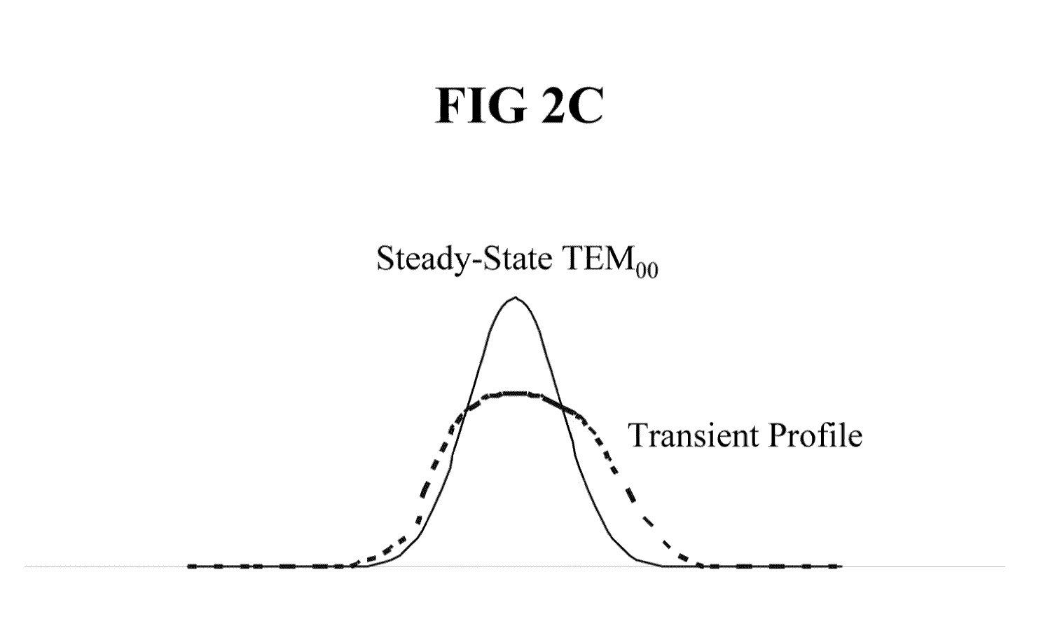

It is therefore an object of the present invention to provide for a method for eliminating or reducing spatial mode hop. According to the present invention, the laser is repetitively turned on and off at a frequency so high that in each cycle the intracavity laser propagates only a few round trips whereby the lowest order lateral modes, in particular the fundamental mode TEM₀₀, have insufficient time to grow to their steady-state levels or to where they dominate over higher-order modes. Transient distribution of the laser lateral modes and its dependence on the number of round trips propagated within each on-off cycle are graphically illustrated in FIG. 2A. Parameters that may affect the number of round trips in each on-off cycle at a given DC bias and threshold include modulation waveform, frequency, and the degree of modulation. Of course, these parameters may also influence other properties of the laser such as noise, stability, and average power of laser output. Therefore, selection of the optimal modulation parameters requires comprehensive consideration of these factors.

Since lasing initiates with randomly distributed lateral modes, with repeated on-off cycles of sufficiently high rates, a stable and uniform or nearly uniform pattern of illumination can be obtained by statistical average of transient lateral modes over time. A conceptual illustration of this process is given in FIG. 2B. It is important to note that for a sufficiently high on-off rate the transient distribution of the laser lateral modes varies from one cycle to another and such variation is stochastic. Purely for the sake of convenience in illustration, trapezoid waves are displayed in FIGS. 2A and 2B. This is by no means a limitation to the modulation waveform.

In comparison with their steady-state counterparts, the transient or unsteady-state lateral modes are broadened in the intensity distribution and the profiles are changing with time randomly. As an example, FIG. 2C compares steady-state TEM₀₀ mode and a transient profile of the fundamental mode. In real operation, multiple transient lateral modes coexist and their profiles rapidly vary with time. Superimposition of plurality of transient lateral modes at any instant of time results in an instantaneous profile with reduced contrast in the intensity distribution. Time average of these instantaneous profiles makes the illumination field uniform or nearly uniform across the aperture.

In many applications, repeated on-off operation of the laser emitter is not necessary to obtain stable and uniform or nearly uniform illumination over an area. By reducing the degree of modulation such that the drive current is always above the threshold, the laser operates in a continuous or quasi-continuous mode. Nevertheless, since the gain, loss, refractive index, and the emission spot all are associated with the excited carrier density injected into the stripe region of the active layer, as the drive current continuously varies in high rate, in particular, in a rate considerably higher than 0.1 mA/ns on average, depending on the laser characteristics, each lateral mode is unsteady and continuously changes its profile in accordance with the current. Changes of these unsteady-state profiles are stochastic in nature. For a sufficiently long period of time, the peaks and valleys of the unsteady-state lateral profiles are averaged out, as a consequence, the illumination field tends to be stabilized and the uniformity is improved from the laser emission where RF modulation is not implemented.

Similarly, there are applications allowing more round trips in each on-off cycle. Due to the continuous perturbation of the lateral profiles, the contrast of the observed illumination field is reduced by statistical averages of the unsteady-state lateral profiles. Therefore, even the frequency of the RF modulation is not high enough to avoid domination of low-order lateral modes in each on-off cycle, reduction of spatial and temporal noise and instability of the laser characteristics is still achievable according to the present invention.

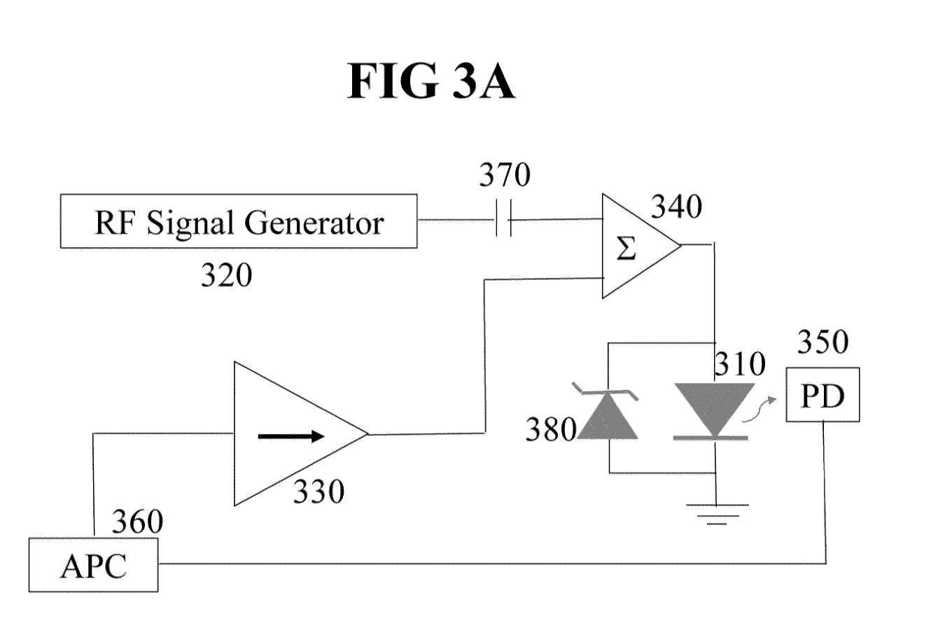

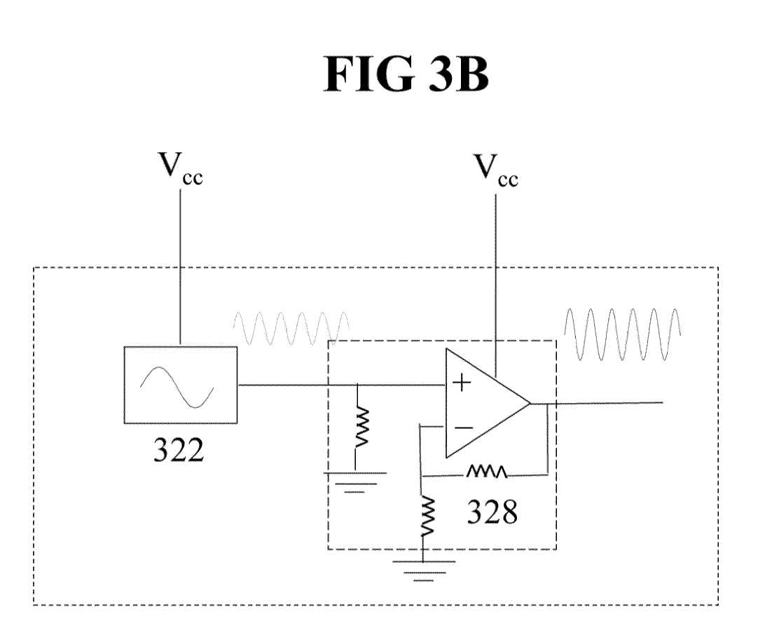

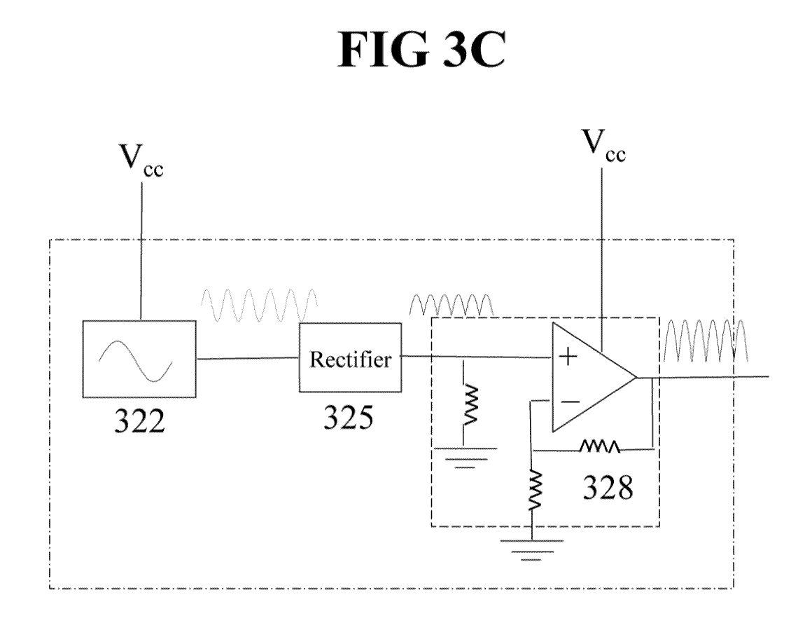

According to the present invention, generation of transient lateral modes in high rates is accomplished by repetitive on-off operation of the laser driven by RF-modulated current. FIG. 3A shows an embodiment of the laser driving circuit that generates drive current alternative below and above the lasing threshold. The driving circuit comprises a DC bias generator 330, an RF signal generator 320, a summing junction 340, a photodiode 350, and an Automatic Power Control (APC) circuitry 360. The RF signal generated in 320 is combined with the DC bias generated in 330 at 340. The resultant drive current with an RF waveform is effectively injected into the laser diode 310. In operation, a portion of the laser emission is directed into the photodiode 350, in which the optical signal is converted to electronic signal. Advantageously, the photodiode is isolated from stray light and other unwanted optical feedback. For enhancing the polarization extinction ratio of the laser output and for improving the detection sensitivity, a polarizer is preferably integrated. The response time of the photodiode is at least 100 ns, which is much longer than a typical period of the alternative drive current. Upon the feedback signal, the APC 360 adjusts the DC bias so that the laser output power is stabilized. The capacitor 370 is to isolate the RF generator from the DC generator, while the clamping diode 380 is to prevent the laser diode 310 from exceeding its safe range at any time instant.

Functional block diagram of an RF generator that generates modulation signal of sinusoid or distorted sinusoid waveform is shown in FIG. 3B. In accordance with this particular embodiment, an oscillator, for instance a crystal oscillator 320, is employed for generating RF signal with low electric noise. The RF signal is then amplified in a current amplifier 328 and is superimposed to the DC bias to provide an RF-modulated drive current. Adjustment of the amplitude of the sinusoid signal relative to the DC bias allows the laser being modulated with various degrees. In particular, if the difference between the DC bias and the RF amplitude is greater than the threshold current, the laser operates in a continuous or quasi-continuous mode. The spatial and temporal stabilization is based on statistical average of unsteady-state lateral modes. On the other hand, if the difference between the DC bias and the RF amplitude is smaller than the threshold current, the laser is periodically turned on and off. Depending on the modulation frequency, the stabilization is achieved by statistical average of transient or unsteady-state lateral modes.

FIG. 3C shows an alternative embodiment of the RF signal generator. A rectifier 325 is employed for rectifying the RF signal generated by the oscillator 320. A rectified sinusoid wave can be expressed as |Iₘ sin(ωt)|+I_{DC}, where Iₘ is the amplitude of the RF sine wave, ω is the frequency, and I_{DC} is the DC bias. Using rectified RF signal has the advantage of increasing the drive current duty cycle and doubling the modulation frequency.

Although the waveforms in FIGS. 3B and 3C are sinusoid including distorted sinusoid and rectified sinusoid, this should not be interpreted as a limitation of the present invention. Other variations and modifications can be brought into effect within the scope of the invention. It should also be mentioned that selection of the modulation parameters can be made on the basis of the characteristics of the laser and in accordance with practical needs.

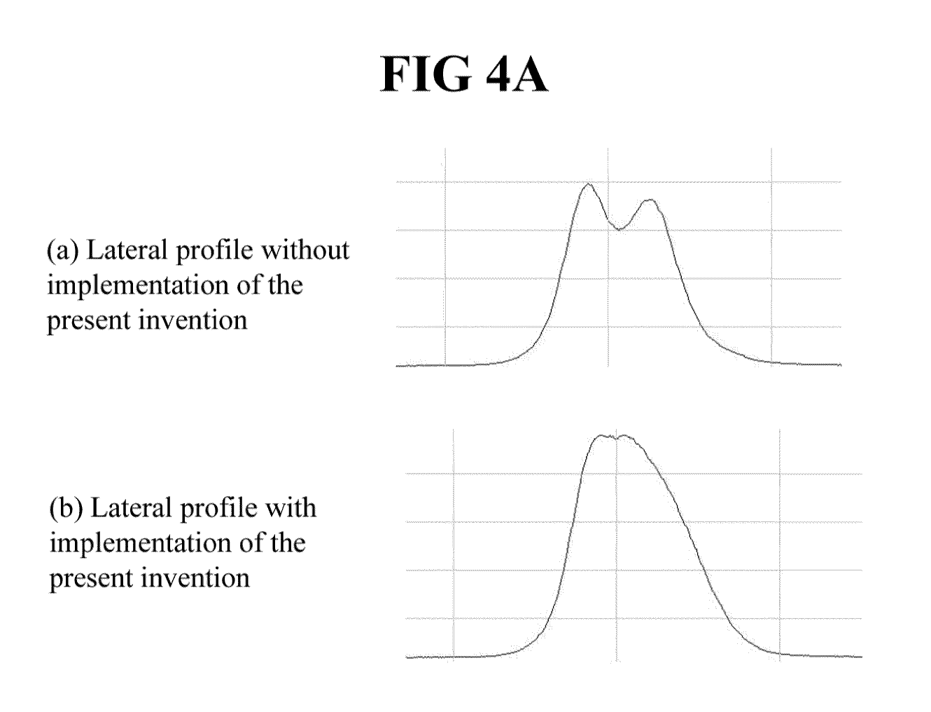

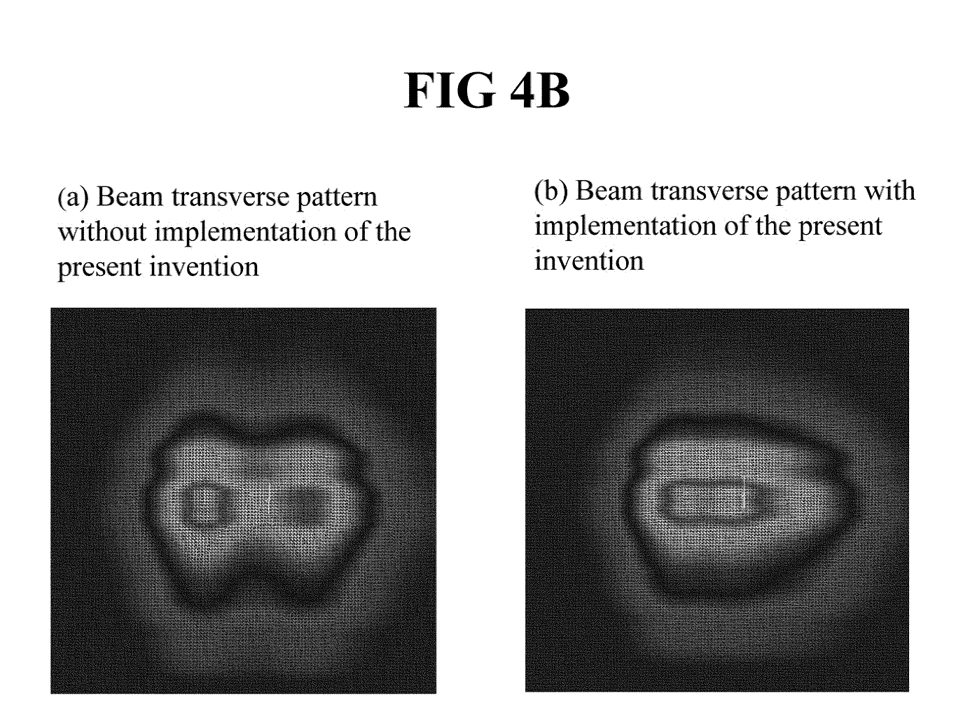

FIGS. 4A and 4B demonstrate experimental results. As shown in FIG. 4A, the lateral intensity profile of a broad laser emitter employing the present invention has much improved uniformity in comparison to the laser emitter without implementation of the present invention. FIG. 4B shows the improvement in the 3D intensity pattern. Further improvement can be achieved by optimizing the operation parameters, namely, the modulation waveform and frequency, and the degree of modulation.

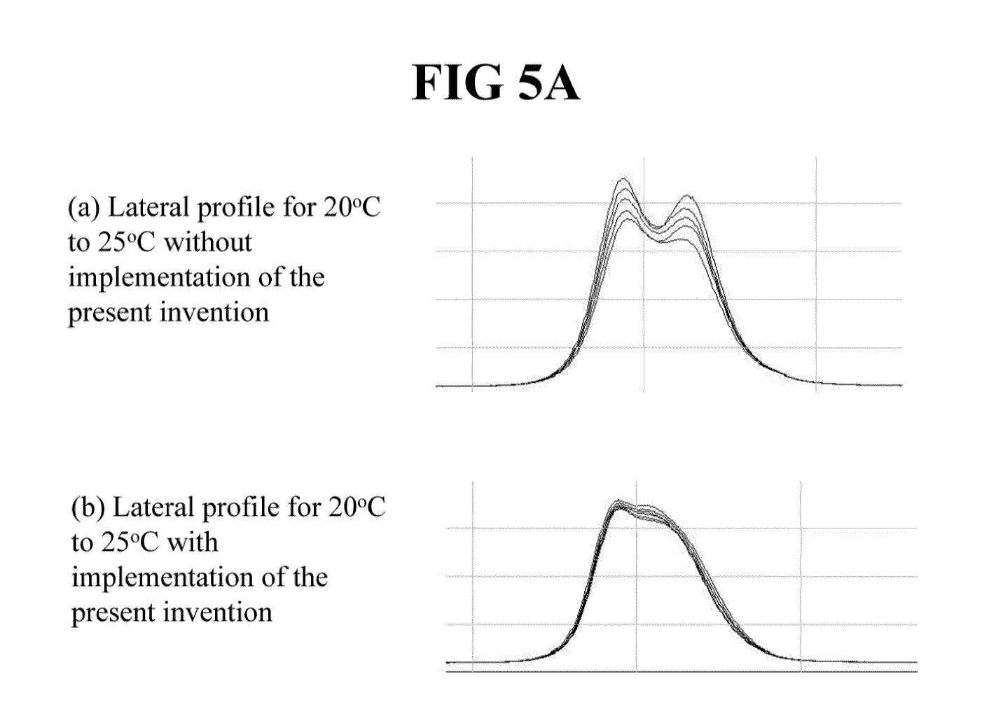

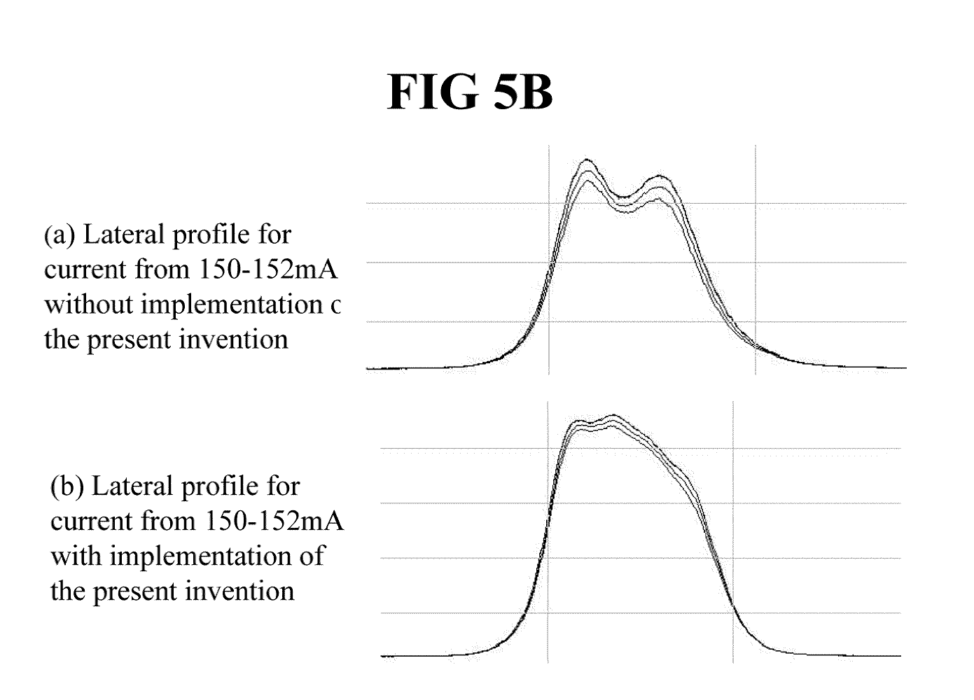

FIGS. 5A and 5B demonstrate experimental results to show substantial improvement in the stability of the lateral profiles by implementation of the present invention. As shown in FIG. 5A, the lateral profile does not have any noticeable change when the operation temperature increases from 20° C. to 25° C. if the present invention is implemented, while the change is much more significant without employing the present invention. FIG. 5B compares the lateral profiles when the DC bias changes from 150 mA to 152 mA. Here again the improvement achieved by implementation of the present invention is convincing.

This invention is particularly useful for applications where stable and uniform illumination of low speckle and low coherence is required and for applications where laser beams of highly elliptical shape are needed. When applied as a pump source, the laser emitters implementing the inventive method provide for improved spatial matching with the solid-state laser gain medium, which is critical for stabilizing solid-state laser operation. Typical beam sizes of the laser emitters that are particularly suitable to applications of the present invention include, but not limited to, 1×5 μm², 1×7 μm², 1×10 μm², 1×15 μm², 1×50 μm², and 1×100 μm².

1.-20. (canceled)

21. A method for operating a broad area semiconductor laser which exhibits a number of lateral modes, said method comprising the steps of:
generating a drive current that alternatively varies above and below the lasing threshold of the broad area semiconductor laser, wherein said alternating variation is at a frequency in the radio frequency range;
injecting the drive current into the broad area semiconductor laser such that the semiconductor laser is repetitively turned on and off and produces a broad area laser beam;
directing a portion of the broad area laser beam to a photodetector having a response time longer than 100 ns, said photodetector being substantially isolated from stray light and any other optical feedback noise;
generating an electronic feedback signal in response to the broad area laser beam received by the photodetector;
providing the electronic feedback signal to an automatic power controller; and
adjusting the drive current bias in response to the feedback signal;
such that the broad area semiconductor laser produces a substantially spatially uniform and temporally-stable output laser beam.

22. The method of claim 21 wherein said drive current exhibits an average rate of change of at least 0.1 mA/ns.

23. The method of claim 22 further comprising the step of:
operating the broad area semiconductor laser with a sufficiently large number of lateral modes such that a superposition of these modes results in a substantially uniform illumination.

24. A method for operating a broad area semiconductor laser comprising the steps of:
generating a periodically varying drive current exhibiting a frequency of variation in the radio frequency range and an average rate of change of at least 0.1 mA/ns; and
injecting the drive current into the broad area semiconductor laser such that the broad area semiconductor laser produces a broad area laser beam exhibiting a substantially uniform and stable illumination field.

25. The method of claim 24 further comprising the step of:
operating the broad area semiconductor laser with a sufficiently large number of lateral modes such that a superposition of these modes results in a substantially uniform illumination.
